(19) United States
(12) Patent Application Publication
(10) Pub. No.: US 2022/0005341 A1
(43) Pub. Date: Jan. 6, 2022

(54) METHOD AND SYSTEM FOR DETECTING PRESENCE OF A PROTECTIVE CASE ON A PORTABLE ELECTRONIC DEVICE DURING DROP IMPACT

(71) Applicant: World Wide Warranty Life Services Inc., Port Moody (CA)

(72) Inventors: Richard Hui, Coquitlam (CA); Anthony Daws, Vancouver (CA); Ebrahim Bagheri, Toronto (CA); Fattane Zarrinkalam, North York (CA); Hossein Fani, Toronto (CA); Samad Paydar, North York (CA)

(21) Appl. No.: 17/291,876

(22) PCT Filed: Nov. 7, 2019
(86) PCT No.: PCT/CA2019/051590

§ 371 Date: May 6, 2021

Related U.S. Application Data
(60) Provisional application No. 62/756,721, filed on Nov. 7, 2018.

(51) Int. Cl. G08B 21/18; H04B 1/3888

(52) U.S. Cl. CPC G08B 21/18; H04B 1/3888

(57) ABSTRACT

Various embodiments for detecting presence of a protective case on a portable electronic device during a drop impact of the device are described herein. Generally, the method for detecting presence of a protective case on a portable electronic device during a drop impact of the device involves receiving a first indication that the portable electronic device is dropping; collecting sensor data generated from at least one sensor; receiving a second indication that the portable electronic device has experienced the drop impact; analyzing sensor data generated by the at least one sensor during a time frame between receiving the first indication and the second indication; and determining an output result based on the analyzing, wherein the output result indicates either: (i) the portable electronic device was protected by a protective case during drop impact; or (ii) the portable electronic device was not protected by a protective case during drop impact.

### CROSS-REFERENCE TO RELATED PATENT APPLICATION

This application claims the benefit of United States Provisional Patent Application No. 62/756,721, filed Nov. 7, 2018, entitled “A SYSTEM AND METHOD FOR DETECTING IF A DEVICE IS PROTECTED WHEN IT IS DROPPED”. The entire content of U.S. Provisional Patent Application No. 62/756,721, is herein incorporated by reference.

### FIELD

Various embodiments are described herein that generally relate to portable electronic devices and, in particular, to a system and method for detecting the presence of a protective case on a portable electronic device during drop impact.

### BACKGROUND

Portable electronic devices often suffer risk of accidental damage when dropped over hard surfaces (e.g., hardwood, asphalt or concrete). This may occur, for example, when small electronic devices (e.g., cellphones) slip through users' hands, or otherwise, when larger electronic devices (e.g., laptops, or tablet computers) drop from elevated positons (e.g., desks or tables). In various cases, electronic devices may also suffer accidental damage due to incidental contact with hard surfaces during movement.

To mitigate risk of accidental damage, electronic devices are often manufactured using rigid and durable material. Smartphones, for example, can be manufactured using high durability glass surfaces capable of withstanding impact from shoulder-level drops. Similarly, laptops can be manufactured using shock-absorbent, ultra-polymer materials, which provide high-impact protection.

Nevertheless, while rigid and durable material can offer high efficiency protection, manufacturing devices using these materials can significantly increase purchase cost, as well as causing the electronic device to be too heavy or bulky for daily use. Accordingly, a common, widespread and inexpensive alternative has been the use of removable protective casings which are built from shock-absorbent light-weight material. In some cases, protective case manufactures can also provide an additional level of damage protection by offering customers warranty over the case. For example, the warranty can cover damage caused to a device resulting from failure of the case to effectively protect the device from drop impact. In some cases, the warranty can also provide customers rights to request a replacement for their damaged device, provided the device was protected by the case at the time of being dropped.

### SUMMARY OF VARIOUS EMBODIMENTS

In accordance with a broad aspect of the teachings herein, there is provided at least one embodiment of a method for detecting presence of a protective casing on a portable electronic device during a drop impact of the device, the method comprising: receiving, by at least one processor, a first indication that the portable electronic device is being dropped; collecting, by the at least one processor, sensor data generated from at least one sensor coupled to the electronic device; receiving, by the at least one processor, a second indication that the portable electronic device has experienced the drop impact; analyzing, by the at least one processor, sensor data generated by the at least one sensor during a time frame between receiving the first indication and the second indication; and determining, by the at least one processor, an output result based on the analyzing, wherein the output result indicates either: (i) the portable electronic device was protected by a protective case at a moment of drop impact; or (ii) the portable electronic device was not protected by a protective case at the moment of drop impact.

In at least one of these embodiments, the analyzing further comprises: extracting, by the at least one processor, at least one feature from the sensor data generated by the at least one sensor during the time frame; and applying, by the at least one processor, at least one machine learning algorithm to the at least one feature to generate the output result.

In at least one of these embodiments, the machine learning algorithm comprises a binary classifier, and the binary classifier is configured to classify the at least one feature into one of two mutually exclusive classes, including a first class indicating that the electronic device was protected by the protective casing at the moment if drop impact, and a second class indicating that the electronic device was not protected by the protective casing at the moment of drop impact.

In at least one of these embodiments, the machine learning algorithm comprises at least one of Perceptron, a Naive Bayes, a Decision Tree, a Logistic Regression, an Artificial Neural Network, a Support Vector Machine, and a Random Forest algorithm.

In at least one of these embodiments, the at least one feature comprises at least one of frequency values, amplitude values, energy values, data minimum and maximum values of at least one of the frequency, amplitude and energy values, difference between maximum and minimum values of at least one of frequency, amplitude and energy values, data average values of at least one of the frequency, amplitude and energy values, and standard of deviation of the amplitude values from the sensor data in at least one of the time domain and frequency domain.

In at least one of these embodiments, the at least one feature comprises a plurality of features, and the at least one machine learning algorithm comprises a plurality of machine learning algorithms, and a different machine learning algorithm is applied to a different feature to generate a sub-output result, and wherein the sub-output results from each of the plurality of machine learning algorithms is aggregated to generate the output result.

In at least one of these embodiments, the at least one sensor comprises a plurality of sensors that each generate a respective sensor data set during the time frame, and the at least one processor is configured to extract at least one feature from each sensor data set.

In at least one of these embodiments, the at least one sensor comprises at least one of an accelerometer, an ambient temperature sensor, a gyroscope, an accelerometer, a pressure sensor, a magnetometer, a humidity sensor, a global position system (GPS), a moisture sensor, an ambient light sensor, an orientation sensor comprising at least one of a pitch sensor, roll sensor, and yaw sensor, a radar sensor and a sound detecting sensor.

In at least one of these embodiments, when the at least one sensor comprises an imaging sensor, the at least one feature comprises at least one of a histogram of pixel color values, local binary pattern (LBP), histogram of oriented gradients (HOG), JET features, scale-invariant feature transform (SIFT) features, micro-JET features, micro-SIFT features, outline curvature of image objects, and reflectance based features comprising at least one of edge-slice and edge-ribbon features.

In at least one of these embodiments, after receiving the first indication, the method further comprises: initiating, by the at least one processor, a watchdog timer; determining, by the at least one processor, that the watchdog timer has expired; and determining, by the at least one processor, whether the second indication was received before the watchdog timer expired, wherein when the second indication was received before the watchdog timer expired, the second indication that the portable electronic device has experienced the drop is generated, and when the second indication was not received before the watchdog timer expired, then the at least one processor is configured to discard data collected from the at least one sensor.

In at least one of these embodiments, the at least one processor is a processor of the portable electronic device.

In at least one of these embodiments, the method further comprises transmitting to a server, using a communication interface of the electronic device, the output result.

In at least one of these embodiments, the at least one processor comprises at least one first processor of the electronic device, and at least one second processor of a server, and wherein the at least one first processor receives the first indication, collects data generated from the at least one sensor and receives the second indication, wherein a communication interface of the electronic device transmits to the server data collected during the time frame, and wherein the at least one second processor analyzes data collected during the time frame and, determines the output result based on the analyzing.

In at least one of these embodiments, the server is a cloud server.

In accordance with another broad aspect of the teachings herein, there is provided at least one embodiment of a system for detecting the presence of a protective case on an electronic device during a drop impact of the device, the system comprising: at least one sensor coupled to the electronic device; at least one processor in communication with the at least one sensor, the at least one processor operable to: receive a first indication that the electronic device is being dropped; collect sensor data generated from the at least one sensor; receive a second indication of the drop impact of the electronic device; analyze sensor data generated by the at least one sensor during a time frame defined between the first indication and the second indication; and determine, based on the analysis, an output result based on the analyzing, wherein the output result indicates that either: (i) the electronic device was protected by a protective case at a moment of drop impact; or (ii) the electronic device was not protected by a protective case at the moment of drop impact.

In at least one of these embodiments, to analyze the sensor data, the at least one processor is operable to: extract at least one feature from the sensor data generated by the at least one sensor during the time frame; and apply at least one machine learning algorithm to the at least one feature to generate the output result.

In at least one of these embodiments, the machine learning algorithm comprises a binary classifier, and the binary classifier is configured to classify the at least one feature into one of two mutually exclusive classes, including a first class indicating that the electronic device was protected by the protective casing at the moment of drop impact, and a second class indicating that the electronic device was not protected by the protective casing at the moment of drop impact.

In at least one of these embodiments, the machine learning algorithm comprises at least one of Perceptron, a Naive Bayes, a Decision Tree, a Logistic Regression, an Artificial Neural Network, a Support Vector Machine, and a Random Forest algorithm.

In at least one of these embodiments, the at least one feature comprises at least one of frequency values, amplitude values, energy values, data minimum and maximum values of at least one of the frequency, amplitude and energy values, difference between maximum and minimum values of at least one of frequency, amplitude and energy values, data average values of at least one of the frequency, amplitude and energy values, and standard of deviation of the amplitude values from the sensor data in at least one of the time domain and frequency domain.

In at least one of these embodiments, the at least one feature comprises a plurality of features, and the at least one machine learning algorithm comprises a plurality of machine learning algorithms, and a different machine learning algorithm is applied to a different feature to generate a sub-output result, and wherein the sub-output results from each of the plurality of machine learning algorithms is aggregated to generate the output result.

In at least one of these embodiments, the at least one sensor comprises a plurality of sensors that each generate a respective sensor data set during the time frame, and the at least one processor is configured to extract at least one feature from each sensor data set.

In at least one of these embodiments, the at least one sensor comprises at least one of an accelerometer, an ambient temperature sensor, a gyroscope, an accelerometer, a pressure sensor, a magnetometer, a humidity sensor, a global position system (GPS), a moisture sensor, an ambient light sensor, an orientation sensor comprising at least one of a pitch sensor, roll sensor, and yaw sensor, a radar sensor and a sound detecting sensor.

In at least one of these embodiments, when the at least one sensor comprises an imaging sensor, the at least one feature comprises at least one of a histogram of pixel color values, local binary pattern (LBP), histogram of oriented gradients (HOG), JET features, scale-invariant feature transform (SIFT) features, micro-JET features, micro-SIFT features, outline curvature of image objects, and reflectance based features comprising at least one of edge-slice and edge-ribbon features.

In at least one of these embodiments, after receiving the first indication, the at least one processor is further operable to: initiate a watchdog timer; determine that the watchdog timer has expired; and determine whether the second indication was received before the watchdog timer expired, wherein when the second indication was received before the watchdog timer expired, the second indication that the portable electronic device has experienced the drop is generated, and when the second indication was not received before the watchdog timer expired, then the at least one processor is operable to discard data collected from the at least one sensor.

In at least one of these embodiments, the at least one processor is a processor of the portable electronic device.

In at least one of these embodiments, the processor is further operable to transmit, via a communication interface, the output result to a server.

In at least one of these embodiments, the at least one processor comprises at least one first processor of the electronic device, and at least one second processor of a server, and wherein the at least one first processor is operable to receive the first indication, collect data generated from the at least one sensor and receive the second indication, wherein a communication interface of the electronic device is operable to transmit to the server data collected during the time frame, and wherein the at least one second processor is operable to analyze data collected during the time frame and, determine the output result based on the analyzing.

In at least one of these embodiments, the server is a cloud server.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1A is a schematic representation showing a front view of an example smartphone device.

FIG. 1B is a schematic representation showing a rear perspective view of the smartphone device of FIG. 1A, and showing a partially applied protective case.

FIG. 2 is a simplified diagram of an example embodiment of a system for detecting the presence of a protective case on a portable electronic device during drop impact in accordance with the teachings herein.

FIG. 3 is a simplified block diagram of an example embodiment of a portable electronic device in accordance with the teachings herein.

FIG. 4 is a process flow for an example embodiment of a method for determining the presence of a protective case on a portable electronic device during drop impact, according to some embodiments in accordance with the teachings herein.

FIG. 5 is a process flow for an example embodiment of a method for analyzing data to determine the presence of a protective case on an electronic device during drop impact in accordance with the teachings herein.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems or methods having all of the features of any one of the devices, systems or methods described below or to features common to multiple or all of the devices, systems or methods described herein. It is possible that there may be a device, system or method described herein that is not an embodiment of any claimed subject matter. Any subject matter that is described herein that is not claimed in this document may be the subject matter of another protective instrument, for example, a continuing patent application, and the applicants, inventors or owners do not intend to abandon, disclaim or dedicate to the public any such subject matter by its disclosure in this document.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the example embodiments described herein.

It should also be noted that the terms “coupled” or “coupling” as used herein can have several different meanings depending in the context in which these terms are used. For example, the terms coupled or coupling can have a mechanical, fluidic or electrical connotation. For example, as used herein, the terms coupled or coupling can indicate that two elements or devices can be directly connected to one another or connected to one another through one or more intermediate elements or devices via an electrical or magnetic signal, electrical connection, an electrical element or a mechanical element depending on the particular context. Furthermore, coupled electrical elements may send and/or receive data.

Unless the context requires otherwise, throughout the specification and claims which follow, the word “comprise” and variations thereof, such as, “comprises” and “comprising” are to be construed in an open, inclusive sense, that is, as “including, but not limited to”.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result is not significantly changed. These terms of degree may also be construed as including a deviation of the modified term, such as by 1%, 2%, 5% or 10%, for example, if this deviation does not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

Reference throughout this specification to “one embodiment”, “an embodiment”, “at least one embodiment” or “some embodiments” means that one or more particular features, structures, or characteristics may be combined in any suitable manner in one or more embodiments, unless otherwise specified to be not combinable or to be alternative options.

As used in this specification and the appended claims, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the Disclosure provided herein are for convenience only and do not interpret the scope or meaning of the embodiments.

Similarly, throughout this specification and the appended claims the term “communicative” as in “communicative pathway,” “communicative coupling,” and in variants such as “communicatively coupled,” is generally used to refer to any engineered arrangement for transferring and/or exchanging information. Examples of communicative pathways include, but are not limited to, electrically conductive pathways (e.g., electrically conductive wires, electrically conductive traces), magnetic pathways (e.g., magnetic media), optical pathways (e.g., optical fiber), electromagnetically radiative pathways (e.g., radio waves), or any combination thereof. Examples of communicative couplings include, but are not limited to, electrical couplings, magnetic couplings, optical couplings, radio couplings, or any combination thereof.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a keyboard, mouse, touchscreen, or the like), and at least one output device (e.g. a display screen, a printer, a wireless radio, or the like) depending on the nature of the device.

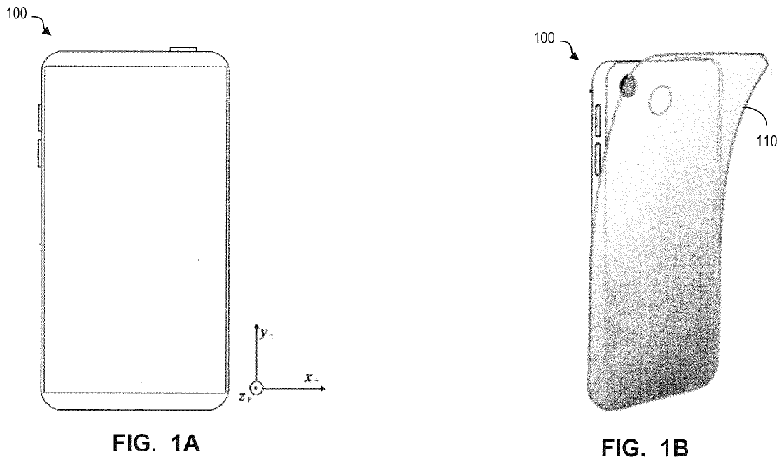

As mentioned in the background, removable protective casings have become a widespread and inexpensive solution to providing accidental damage protection for portable electronic devices. For example, as shown in FIGS. 1A and 1B, a removable protective casing 110 may be applied around the side and back ends of a smartphone device 100 to protect against accidental drops. In various cases, the protective casing 110 can be built from shock-absorbent light-weight material.

In at least some cases, protective case manufactures can offer customers an additional level of damage coverage by providing a warranty for the protective case. For example, the warranty can cover damage to an electronic device from failure of the case to provide effective drop protection. In some cases, warranties can also offer customers right to request a replacement for damaged electronic devices, provided the device was protected by the casing at the time of impact. Nevertheless, a challenge faced with providing warranty protection of this nature is that warranty service providers may be exposed to incidences of fraud. For example, unscrupulous customers may simply apply the protective case to their electronic device after the damage has occurred. The customer may then request reimbursement or replacement, from the manufacturer or an independent warranty servicer, while falsely claiming that the protective case was applied at the time of damage.

At present, there are no reliable methods to accurately determine whether a protective case was applied to an electronic device during impact damage (e.g., drop impact). In particular, current methods are only able to detect the instance when a device is dropped, and the instance when a device contacts a ground surface. However, these same methods are not able to provide further insights as to whether a dropped electronic device was protected by a protective casing during drop impact.

In view of the foregoing, the teachings provided herein are directed to at least one embodiment of a method and system for detecting the presence of a protective casing on an electronic device during drop impact. In at least some example applications, methods and systems provided herein may allow a protective case manufacturer, in collaboration with warrantors or individually, to validate a claim on a warranty which requires the presence of a protective case. Accordingly, this can assist in reducing incidences of fraud, and in turn, reducing the cost to warranty providers.

In accordance with teachings herein, the presence of a protective casing on an electronic device during drop impact may be determined using one or more sensors coupled to the electronic device and/or protective casing. Sensor data can be collected between a time instance when a potential drop is first detected, and a time instance when drop impact is detected. Using the sensor data, one or more features can be extracted and fed to a trained machine learning algorithm. In various cases, the machine learning algorithm can be a binary classifier which analyzes the input features, and determines whether the input features correspond to one of two situations: (i) an electronic device is protected by a protective casing at the moment of drop impact, or (ii) an electronic device is not protected by a protective casing at the moment of drop impact.

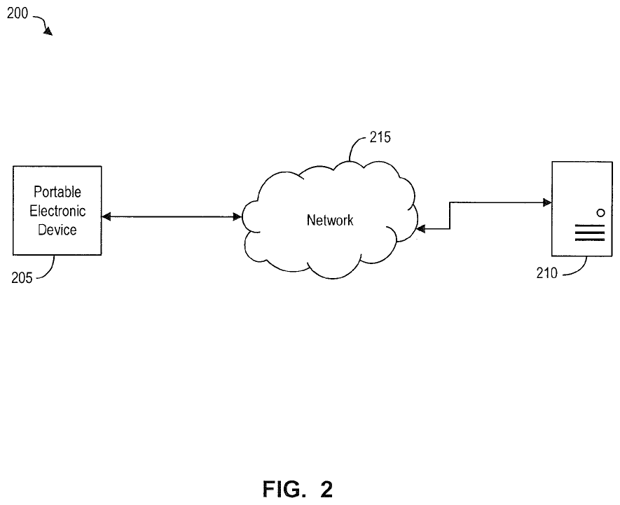

Referring now to FIG. 2, there is shown a diagram for an example embodiment of a system 200 for detecting the presence of protective casing on an electronic device during drop impact in accordance with the teachings herein. System 200 generally provides the environment in which the devices and/or methods described herein generally operate.

As shown, system 200 can include a portable electronic device 205 in data communication with a remote terminal (or server) 210. The electronic device 205 may communicate with the remote server 210 through a network 215. Network 215 may be, for example, a wireless personal area network such as a Bluetooth™ network, a wireless local area network such as the IEEE 802.11 family of networks or, in some cases, a wired network or communication link such as a Universal Serial Bus (USB) interface or IEEE 802.3 (Ethernet) network, or others. In some embodiments, the electronic device 205 may communicate with the server 210 in real-time. In other embodiments, the electronic device 205 may store data for later transmission to server 210.

Server 210 can be a computer server that is connected to network 215. Server 210 has a processor, volatile and non-volatile memory, at least one network interface, and may have various other input/output devices. There may be a plurality of devices in the system 200 as well as multiple servers 210, although not all are shown for ease of illustration. In various cases, the server 210 can be associated, for example, with a manufacturer of protective cases and/or portable electronic devices, or otherwise, with a warranty provider that provides warranties for protective cases and/or portable electronic devices.

In various cases, server 210 can receive, from the electronic device 205, via network 215, an indication of whether a protective case was applied to the electronic device 205 when there was an incident of drop impact. Accordingly, this can allow a manufacturer of protective casings, or an independent warranty provider, to validate a claim on warranty for the protective case and/or the portable electronic device 205 when there is damage to the device 205 and/or the protective casing during the drop incident.

In other embodiments, as explained in further detail herein, server 210 may not receive an indication regarding the presence of a protective case, but rather, may receive raw sensor data and/or extracted feature data, from electronic device 205, generated during a drop impact incident. The server 210 may then analyze the data and/or extracted features to determine whether a protective case was applied to the electronic device 205 during drop impact.

It will be understood that the server 210 need not be a dedicated physical computer. For example, in various embodiments, the various logical components that are shown as being provided on server 210 may be hosted by a “cloud” hosting service.

Portable electronic device 205 generally refers to any portable electronic device, including desktop, laptop, tablet computers, or a mobile device (e.g., cell phone, or smart phone). It will be appreciated that electronic device 205 can also refer to a wide range of electronic devices capable of data communication. Like server 210, electronic device 205 includes a processor, a volatile and non-volatile memory, at least one network interface, and input/output devices. In various cases, as explained herein, the electronic device 205 is sensor-equipped. The electronic device 205 may at times be connected to network 215 or a portion thereof. In at least some embodiments, the electronic device 205 is protected by a protective casing.

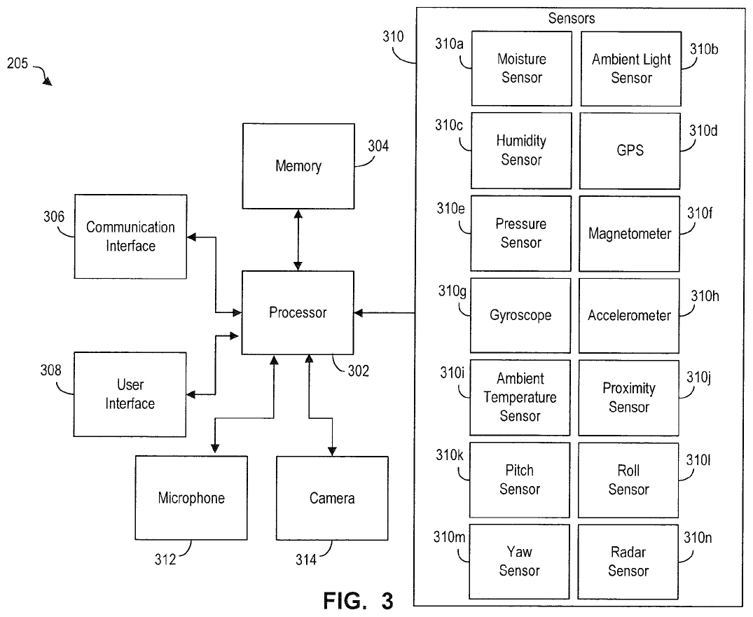

Referring now to FIG. 3, there is shown a simplified block diagram of an example embodiment of a portable electronic device 205 in accordance with the teachings herein. As shown, the portable electronic device 205 generally includes a processor 302 in communication with a memory 304, a communication interface 306, a user interface 308 and one or more sensors 310. In some cases, the processor 302 may also communicate with a microphone 312 (or any ambient sound detection sensor), and optionally, a camera 314 (or an image sensor).

Processor 302 is a computer processor, such as a general purpose microprocessor. In some other cases, processor 302 may be a field programmable gate array, application specific integrated circuit, microcontroller, or other suitable computer processor.

Processor 302 is coupled, via computer data bus, to memory 304. Memory 304 may include both a volatile and non-volatile memory. Non-volatile memory stores computer programs consisting of computer-executable instructions, which may be loaded into volatile memory for execution by processor 302 as needed. It will be understood by those skilled in the art that reference herein to electronic device 205 as carrying out a function, or acting in a particular way, imply that processor 302 is executing instructions (e.g., a software program) stored in memory 304 and possibly transmitting or receiving input data and output data via one or more interfaces. Memory 304 may also store input data to, or output data from, processor 302 in the course of executing the computer-executable instructions.

In various embodiments provided herein, memory 304 can receive, and store, sensor data generated by one or more sensors 310, microphone 312 and/or camera 314. For example, memory 304 can store sensor data generated while the electronic device 205 is being dropped. As explained herein, processor 302 can retrieve the stored sensor data from memory 304, and can use the sensor data to extract one or more features. The extracted features may then be returned for storage on the memory 304. In some cases, memory 304 can also store information regarding device specifications for the specific electronic device 205.

In at least some embodiments, memory 304 can further store parameters associated with one or more machine learning algorithms. As explained herein, the machine learning algorithms can be used by processor 302 to process features extracted from sensor data in order to determine whether an electronic device was protected by a protective casing during drop impact. In at least some embodiments, the output of the machine learning algorithm may be returned for storage on memory 304.

In some cases, rather than directly storing machine learning algorithm parameters, memory 304 can store a software program or application which hosts a machine learning algorithm. The application, or program may be a standalone application or software program that is downloaded or installed on the electronic device 205. In other cases, the program may be integrated into a third-party software application or program, which itself, is downloaded or installed on the electronic device 205.

In other embodiments, as explained herein, the machine learning algorithm may not be stored on memory 304, but rather, may be stored on server 210. In these cases, raw sensor data, device specifications and/or extracted feature data may be transmitted to server 210 for processing using the machine learning algorithm. In these embodiments, memory 304 may simply store a software program or application which collects sensor data, and which can transmit the sensor data to server 210. The software program or application may also store instructions for extracting feature data from the sensor data, which may then be transmitted to server 210.

Communication interface 306 is one or more data network interface, such as an IEEE 802.3 or IEEE 802.11 interface, for communication over a network.

User interface 308 may be, for example, a display for outputting information and data as needed. In particular, user interface 308 can display a graphical user interface (GUI). In some embodiments, the user interface 308 can inform a user, about certain aspects of electronic device 205 such as, but not limited to the state of their warranty protection of their device. For example, a user can be informed that they are not protected after the electronic device has been dropped a pre-determined number of times. In some cases, user interface 308 may also provide an option for a user to consent to transmitting sensor data, extracted feature data, device specifications, or an output of a machine learning algorithm, to server 210. For example, a user may consent to transmitting this data to server 210 when seeking re-imbursement under a warranty claim for a damaged protective case and/or electronic device. Accordingly, the warranty provider, associated with server 210, may use the data to validate the warranty claim.

Electronic device 205 also includes one or more sensors 310. Sensors 310 can collect (or monitor) sensor data that is generated when an electronic device 205 is dropped. As shown in FIG. 3, sensors 310 can generally include, by way of non-limiting examples, at least one of moisture sensors 310a, ambient light sensors 310b, humidity sensors 310c, ground positioning sensors (GPS) 310d, pressure sensors 310e, magnetometers 310f, gyroscopes 310g, accelerometers 310h, ambient temperature sensors 310i, and proximity sensors 310j. In at least some embodiments, sensors 310 can also include one or more orientation sensors, including pitch sensor 310k, roll sensor 310l and/or yaw sensor 310m. As well, sensors 310 can additionally include a radar sensor 310m (e.g., motion sensor).

In various cases, as explained herein, the sensor data generated by each of sensors 310 can assist in determining whether a protective case was applied to the electronic device 205 during drop impact. For example, it has been appreciated that an electronic device 205 having a protective case may experience a different “bounce trajectory” when impacting a hard surface, as compared to an electronic device without a protective case. For example, an electronic device having a protective case may bounce back at a higher elevation than an electronic device which does not have a protective case. Accordingly, in at least one embodiment, sensor data from sensors 310 can be used to determine the “bounce trajectory” for different electronic devices 205. For example, in at least one embodiment, pressure sensor 310e (e.g., a barometer) may record different pressures at different heights as sensor data, which can be used to determine how high the electronic device 205 has bounced after impacting a surface such as the ground surface, a floor, a table, a desk, stairs and the like. Similarly, accelerometer 310h may record different acceleration data when a device protected by a casing bounces on a ground surface, as compared to a device without a protective casing. Still further, in some other embodiments, sensor data from one or more orientation sensors (e.g., pitch sensor 310k, roll sensor 310l and/or yaw sensor 310m) can be used for determining the bounce trajectory of an electronic device 205 by tracking the bounce trajectory motion of the electronic device. In various cases, sensors 310 may transmit sensor data to processor 302, memory 304 and/or communication interface 306, continuously, or otherwise, at pre-defined time or frequency intervals. In some cases, sensors 310 may only transmit sensor data upon requests made by processor 302.

In various embodiments, sensors 310 may be located inside of the electronic device 205. Alternatively, in other embodiments, some or all of the sensors 310 can be located externally to the electronic device 205. For example, some sensors can be located on the protective case 110. In these cases, the sensors can be in communication (e.g., wired or wireless communication) with processor 302 and/or server 210.

In some embodiments, electronic device 205 can include a microphone 312, or otherwise, any ambient sound detection sensor. As explained herein, microphone 312 can sense acoustic data that can be used to detect sound frequency patterns which can be used, alone or in conjunction with at least one other sensor 310, to determine whether a protective case was applied to a device during drop impact. For example, the sound frequency patterns generated when a protective case is applied to an electronic device may differ from the sound frequency patterns generated when there is no protective case applied to the device. In at least some embodiments, sound data from microphone 312 may also assist in determining whether an electronic device is protected by a protective casing when the electronic device 205 is not otherwise sensor-equipped.

Electronic device 205 may also include a camera 314, or otherwise, any suitable image sensor. In at least some embodiments, camera 314 can be used to capture images of the environment surrounding the electronic device 205 at the time of drop. In various cases, as explained herein, image and/or video data generated by camera 315 can be used to assess, for example, the height at which the electronic device 205 was dropped, and the surface type which the electronic device 205 impacts during a drop (e.g., wooden surface, soft surface, plastic surface, glass, soil, rock, etc.). This information can be determined using any suitable image processing algorithm, which can be performed using processor 302 and/or server 210. For example, in some cases, surface material recognition can be performed by extracting a rich set of low and mid-level features that capture various aspects of the material appearance of the surface, and using a Latent Dirichlet Allocation (aLDA) model to combine these features under a Bayesian generative framework to learn an optimal combination of features which identify the material in the image. In other cases, the height of the electronic device 205 can be determined, for example, by analyzing one or more successive images in conjunction with information about the estimated object size of known objects in the image (e.g., identified via object recognition algorithm). In various embodiments, information from image and/or video data can be used in conjunction with sensor data to determine whether a protective case was applied to the electronic device 205 at the time of drop. For example, image or video data from camera 315 can be analyzed to determine the surface type (e.g., wooden surface). This, in turn, can help to better contextualize bounce trajectory data received from sensors 310. In particular, bounce trajectory data can be different when the electronic device 205 bounces on a hard surface (e.g, wooden surface), as compared to a soft surface (e.g., a carpet). In still other embodiments, the surface type may be determined from image and/or video data by analyzing one or more aspects of the surrounding environment captured in the image and/or video data. For example, image data can be analyzed to determine the presence of trees, plants, etc. in the surrounding environment, and the absence of buildings. Accordingly it can be determined, with high probability, that the electronic device is being dropped, for example, in a forest. Accordingly, the drop surface type can be predicted to be a soft surface (e.g., soil). In some other cases, image and video data from camera 315 may be also transmitted, via communication interface 306, to server 210 to assist, for example, a warranty underwriter to determine if the condition of warranty was satisfied at a moment of drop.

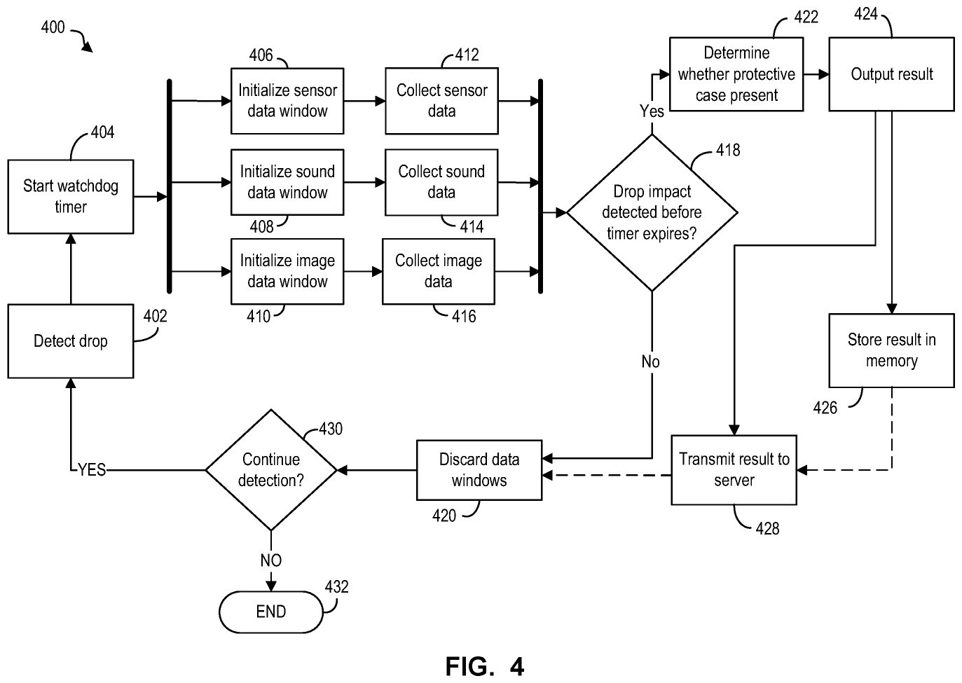

Referring now to FIG. 4, there is shown a process flow diagram for an example embodiment of a method 400 for detecting the presence of a protective case on an electronic device during drop impact in accordance with the teachings herein. Method 400 can be implemented, for example, using processor 302 of FIG. 3.

As shown, at act 402, processor 302 can detect whether the electronic device 205 has been dropped, or otherwise, whether a possible drop may occur. In various cases, the determination at act 402 is made using sensor data from one or more sensors 310, microphone 312 and/or camera 314. For example, processor 302 can monitor accelerometer data generated by accelerometer 310h to determine whether the acceleration has surpassed a pre-determined acceleration threshold value (e.g., the acceleration is less than 0.58 mm/s²). In cases where the acceleration has surpassed the acceleration threshold value, this can indicate that the electronic device 205 has been potentially dropped. In other cases, processor 302 can monitor gyroscope data generated by gyroscope 310g to also determine from the gyroscope data if there are sufficient changes in the yaw, pitch or roll of the electronic device 205, which may also indicate a potential drop.

At act 404, in at least some embodiments, the processor 302 can initiate a watchdog timer. The watchdog timer can be initiated concurrently, or immediately after, detecting a potential drop, at act 402. As explained herein, the watchdog timer can be used to determine whether the drop signal, at act 402, was a false signal. For instance, in some cases, acceleration detected at act 402 may result from sudden movement of the electronic device, rather than from the device being dropped. Accordingly, the watchdog timer can be set to expire after a period of time in which drop impact, of the electronic device, is expected to occur. For example, the watchdog timer can be set to expire 10 seconds to 1 minute after the drop signal, at act 402, is detected. If drop impact is not detected within the threshold period, processor 302 can determine that the drop signal at act 402 was a false signal.

At act 406, once a drop has been detected at act 402, processor 302 can initialize an empty sensor data window, inside of memory 304. The sensor data window is configured to store sensor data from one or more sensors 310.

In some embodiments, at act 408, processor 302 can also initialize an empty sound data window, inside memory 304, for storing sound data from microphone 312. Similarly, at act 410, processor 302 can initialize an empty image data window, inside memory 304, for storing image and/or video data captured by camera 315. In some cases, acts 408 and 410 may occur concurrently with act 406.

At acts 412, 414 and 416, processor 302 may collect and store, inside of the data windows generated in memory 408, sensor, sound and image data generated by one or more of sensors 310, microphone 312, and camera 314, respectively, while electronic device 205 is being dropped. In various cases, at acts 412-416, processor 302 may also activate one or more of sensors 310, microphone 312 and camera 314, to collect data.

At act 418, processor 302 may determine whether the watchdog timer has expired, or otherwise, whether drop impact of the electronic device has been detected, depending on which event occurs first. In at least some embodiments, drop impact can be detected in a similar manner as the initial drop at act 402. For example, processor 302 can determine whether acceleration data from the accelerometer 310h has exceeded a pre-determined accelerometer threshold value indicating a drop impact. Otherwise, processor 302 can determine drop impact based on gyroscope data from gyroscope 310g, or sensor data from any other sensor 310 that can be used to detect a drop impact.

At act 418, if the watchdog timer has expired before drop impact was detected, processor 302 can determine that the drop signal, at act 402, was a false signal. Accordingly, at act 420, processor 302 can stop collecting sensor, sound and/or image data, and can simply discard the sensor, sound and/or image data collected in the corresponding data windows at acts 412-416, respectively. Method 400 can then proceed to act 430, wherein processor 302 can determine whether or not to continue monitoring for new drop signals. For example, in some cases, processor 302 may continue monitoring for new drops signals after waiting a pre-determined period of time corresponding to the time it takes a user to pick-up the dropped device from the ground (e.g., 1-2 minutes). In cases where processor 302 continues monitoring for new drop signals, method 400 can continue to act 402 to re-iterate. Otherwise, method 400 may terminate at act 432.

In other cases, where a drop impact is detected before the watchdog timer has expired, then method 400 can proceed to act 422. At act 422, processor 302 may stop collecting the sensor, sound and/or image data, and may begin analyzing the sensor, sound and/or image data to determine whether a protective case was applied to the electronic device 205 during drop impact. In some cases, once drop impact is detected, processor 302 may not immediately stop collecting sensor, sound and/or image data, but may resume collecting the sensor, sound and/or image data for a short period of time after detecting drop impact (e.g., 1 second to 1 minute). In particular, this may allow the processor 302 to collect the sensor, sound and/or image data in respect of the “bounce trajectory” of the electronic device 205, which can occur immediately after drop impact.

At act 424, based on the analysis at act 422, the output result is generated. The output result can indicate either that a protective casing was applied to the electronic device during drop impact, or alternatively, that no protective casing was applied to the electronic device during drop impact.

In some embodiments, at act 426, the processor 302 may store the results in memory 304. Subsequently, the processor 302 may transmit the results to server 210, via network 215, at act 428. For example, the processor 302 may transmit the results to server 210 upon a request from server 210 to processor 302. For instance, at a time when a user, of electronic device 205, requests re-imbursement from a warranty provider for damages to the protective case and/or electronic device, a server 210, associated with a warranty provider, may request the results of act 422 from processor 302. In other cases, processor 302 may only transmit results to server 210 upon consent and/or request of a user of electronic device 205. In still other cases, the processor 302 may directly transmit the results to the server 210, via network 215, at act 428. In particular, this can be done, for example, to prevent tampering of results which are stored on the local memory 304 of electronic device 205.

In at least some embodiments, after generating the output results at act 424 and transmitting and/or storing the result, data collected in the data windows may be discarded at act 420. Method 400 may then proceed to act 430, in which processor 302 determines whether or not to continue monitoring for new drop signals.

While method 400 has been explained with reference to processor 302, it will be appreciated that, in other embodiments, at least a portion of method 400 can be performed by server 210 (e.g., a processor of server 210). For example, in at least some embodiments, data, collected at acts 412-416, may be transmitted to server 210. The data may be automatically transmitted to the server 210 in real-time or near real-time. In other cases, the data may be initially stored on memory 304, and can be subsequently transmitted to server 210 in response to a request by server 210, or otherwise, by consent of a user of the electronic device 205. Server 210 may then analyze the received data, at act 422, to determine whether a protective case was applied to the electronic device 205 during drop impact. The output result may then be stored, temporarily or permanently, on a memory of the server 210.

In still other embodiments, processor 302 may not generate data windows to store data inside of memory 304. In these cases, sensor, sound and/or image data can be automatically transmitted in real-time or near real-time to server 210, as it is being collected.

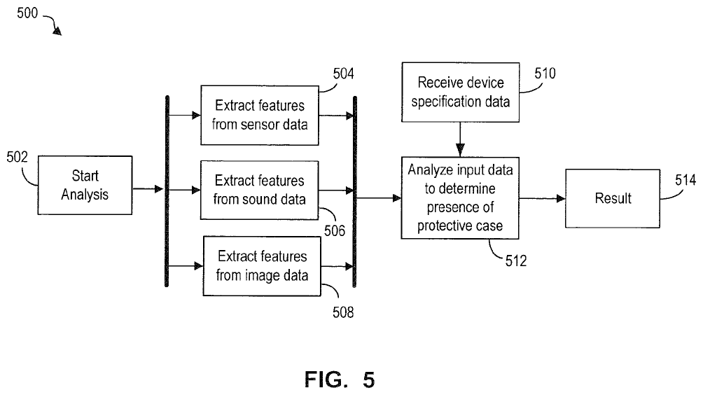

Referring now to FIG. 5, there is shown a process flow for an example embodiment of a method 500 for analyzing sensor, sound and/or image data to determine the presence of a protective case on an electronic device during drop impact in accordance with the teachings herein. Method 500 may correspond to act 422 of method 400.

As shown, at act 502, processor 302 can commence analysis of the sensor, sound and/or image data to determine whether a protective case was applied to the electronic device 205 during drop impact.

At act 504, the processor 302 can retrieve, from memory 304, sensor data collected in the sensor data window in a time frame between when the electronic device 205 was first detected to have been dropped (act 402), and when drop impact was detected, or in some cases, shortly after detecting drop impact (act 418). Processor 302 can then analyze the sensor data to extract one more sensor data features. For instance, by way of non-limiting examples, processor 302 can analyze sensor data from a single sensor to extract sensor data features that includes one or more of frequency values, amplitude values, energy values, data minimum and maximum values of at least one of the frequency, amplitude and energy values, difference between maximum and minimum values of at least one of frequency, amplitude and energy values, data average values of at least one of the frequency, amplitude and energy values, and/or standard of deviation of the amplitude values from the collected sensor data in the time domain. In some embodiments, processor 302 can segment the sensor data from a single sensor in the time domain into sets of multiple time segments. For example, processor 302 can splice accelerometer data into multiple time frames of 0.5 seconds to 1 second per frame. Processor 302 can then extract one or more sensor data features from each time frame. In still some other embodiments, sensor data can be converted into the frequency domain (e.g., using a Discrete Fourier Transform technique) to generate frequency domain data, and at least one sensor data feature can be extracted from the frequency domain data. For example, by way of non-limiting examples, processor 302 can analyze the frequency domain data from a single sensor to extract sensor data features that include one or more of frequency values, amplitude values, energy values, power values, data minimum and maximum values of at least one of the frequency, amplitude, energy and power values, difference between maximum and minimum values of at least one of the frequency, amplitude, energy and power values, data average values of at least one of the frequency, amplitude, energy and power values, and/or standard of deviation of the amplitude values in the frequency domain.

In cases where sensor data is collected from a plurality of sensors 310, at act 504, processor 302 can extract features from sensor data generated by different sensors. For example, processor 302 can separately extract acceleration features from acceleration data generated by accelerometer 310h, and extract orientation features from orientation data generated by the orientation sensors (e.g., pitch sensor 310k, roll sensor 310l and/or yaw sensor 310m) and/or gyroscope data generated by gyroscope 310g.

In some embodiments, at act 506, processor 302 can retrieve sound data stored in a sound data window located in memory 304 (e.g., act 414 of FIG. 4). The sound data may then be analyzed in a similar fashion as the sensor data (as explained previously) to extract one or more sound data features. For example, the sound data can be analyzed in the time or frequency domain to determine sound data features comprising one or more of frequency content, amplitude values, and energy, as well as the minimum, maximum, average and standard of deviation of the amplitude values from the sound data. In still other embodiments, at act 508, processor 302 can also retrieve image data stored in an image data window located in memory 304. The image data can then be analyze to also extract one or more image data features. Examples of image data features can include color features, including histograms of pixel color values for one or more segments of the image. The image data features can also include texture features, JET features, scale-invariant feature transform (SIFT) features, micro-texture features (e.g., micro-JET features or micro-SIFT features), outline curvature of image objects, as well as reflectance based features including edge-slice and edge-ribbon features. In some cases, image data features can also include local binary patterns (LBP), and histograms of oriented gradients (HOG). In some embodiments, acts 506 and 508 can be performed concurrently with act 504. In other cases, acts 504, 506 and 508 can be performed sequentially, one after the other, in any suitable order.

At act 510, the processor 302 can receive device specification data for the electronic device 205. In various cases, the device specification data may be stored on memory 304 of electronic device 205. By way of non-limiting examples, device specification data can include the device type (e.g., mobile, tablet, wearable device), device brand and model information, device weight, as well as device software specifications (e.g., operating system version, etc.).

At act 512, the processor 302 can analyze the features extracted at acts 504-508, as well as the device specification data from act 510, to determine whether a protective case was applied to the electronic device 205 during drop impact. In at least some cases, processor 302 may also analyze raw sensor, sound and image data, collected at acts 412-416 of method 400, to determine whether a protective case was present during drop impact.

In various embodiments, the analysis at act 512 may be performed using one or more machine learning algorithms. The machine learning algorithms can be trained to perform binary classification of input data, wherein the input data can includes one or more of extracted sensor data features, sound data features, image data features, device specification data, and raw sensor, sound and/or image data, to generate an output result. In particular, in binary classification, the machine learning algorithms analyzes the input data, and classifies the input data as belonging to one of two mutually exclusive classes. In the example application of FIG. 5, the one or more machine learning algorithms may be implemented to classify the input data as corresponding to either: (i) an electronic device protected by a protective casing during drop impact; or (ii) an electronic device not protected by a protective casing during drop impact. In various cases, the machine learning algorithm generates a probability value, between 0 and 1, indicating the likelihood that the input data corresponds to either one of the two classes. For example, a probability value closer to ‘0’ can indicate a protective case is present and a probability value closer to ‘1’ can indicate that a proactive case was not present.

In at least some embodiments, the input data fed into the binary classifier can include a combination of sensor, sound and image data features. Accordingly, the binary classifier can analyze and classify the combination of all data features to generate a classification output result. In some cases, where a data feature is missing from the input data, the missing data feature can be substituted by NULL values. In particular, the NULL value can be a specific value that is interpreted by the binary classifier as a data feature which is not included in the input data set. For example, in at least some embodiments, the electronic device 205 may not include a microphone 312 to collect sound data, and accordingly, the input data may not include sound data features. Accordingly, the sound data features can be expressed in the input data as NULL values. Similarly, in other cases, the electronic device 205 may not be sensor-equipped, or otherwise, camera equipped. Accordingly, the input values to the binary classifier may not include sensor data features and/or image data features. As such, the sensor data features or image data features can also be expressed using NULL values. Accordingly, in this manner, the binary classifier is adapted to accommodate different device types which may not include the combination of sensors, microphones and cameras and/or circumstances in which data is not being correctly generated by the sensor, microphone or camera.

In other embodiments, separate binary classifiers can be used to analyze different types of feature data. For example, a first binary classifier can analyze sensor data features, a second binary classifier can analyze sound data features, and a third binary classifier can analyze image data features. In some cases, one binary classifier can analyze two feature data types (e.g., sensor and sound data features), while a second binary classifier can analyze a third feature type (e.g., image data features). Accordingly, each binary classifier can generate a separate classification output, based on the data feature being analyzed. The output of each binary classifier may then be aggregated into a single classification output. For example, the outputs can be aggregated using any one of an average, maximum or minimum aggregation function, or otherwise, using any other suitable aggregation method. In embodiments where a data feature is missing, the output from the respective binary classifier can be disregarded.

In some embodiments, a binary classifier can be a combination of two or more binary classifiers. For example, an ensemble method can be used, in which several machine learning algorithms are combined into a single binary classification model. In some cases, the ensemble method can use more than one type of binary classifier, and an aggregation function can be used to aggregate the individual outputs from each classifier, into a single output (e.g., a bagging method). In various cases, this can be done to improve predictive accuracy of the binary classifier. The one or more machine learning algorithms implemented at act 512 can be trained to perform binary classification using any suitable technique, or algorithm. For example, in some embodiments, the machine learning algorithm can be trained using a supervised learning algorithm.

In a supervised learning algorithm, the machine learning algorithm is trained to classify input data using a training data set. The training data set comprises feature data (e.g., sensor, sound and/or image feature data) which is generated by test dropping electronic devices under different test conditions, as well, in some cases, raw sensor, sound and image data. For example, electronic devices can be dropped from different heights, and/or on different surfaces (e.g., hard, soft, etc.). For each test drop, sensor, sound and/or image data is collected. Data features are then extracted from each type of data collected. The test drops are conducted for cases where the electronic device is protected by a protective casing, and for cases where the electronic device is not protected by a protective casing. The training data is then labelled as corresponding to data collected for electronic devices dropped with a protective casing (e.g., a positive label), and electronic devices dropped without a protective casing (e.g., a negative label). In at least one example case, to generate training data, different types of smartphone devices are dropped a total of 1907 times using a case (e.g., a positive sample), and a total of 1248 times without a case (e.g., a negative sample). The smartphone devices are dropped from different heights (50 cm, 60 cm, 70 cm, 80 cm, 90 cm and 100 cm), and on different surfaces (e.g., soft padded, marble, and hardwood) and using different drop patterns (e.g., straight drop and rotational drop), to obtain different training data sets.

Once the training data is generated, the labelled training data is then fed as input data to the machine learning algorithm so as to allow the algorithm to associate binary labels with different input data sets. The machine learning algorithm may be additionally fed input data corresponding to device specification data (e.g., device type, brand, model etc.) for devices which are test dropped. This can allow the machine learning algorithm to further associate different input data sets with different types of electronic devices.

In at least some embodiments, where a single machine learning algorithm is trained to analyze a combination of all feature data (e.g., sensor, sound and image feature data), the training data fed into the machine learning algorithm can include the combination of all feature data. The training data can also include some training data that includes missing feature data. For example, in some cases, the training data can include data sets where the sensor, sound and/or image feature data is substituted for NULL values. Accordingly, this can allow training of the binary classifier to accommodate cases where one or more of the sound, sensor or image feature data is missing (e.g., cases where the electronic device is not equipped with sensors, microphones and/or cameras). In other embodiments, as explained previously, different machine learning algorithms can be trained to analyze different types feature data. Accordingly, in these cases, the training data fed into each machine learning algorithm only includes the relevant data features (e.g., sound, sensor or image).

In some embodiments, once the machine learning algorithms have been trained, additional data from test drops can be used as validation data. Validation data is used to further fine-tune parameters associated with the machine learning algorithm, and in turn, enhance the algorithms performance setting. Some data from test drops can also be used as test data. In a test data set, “unlabeled” input data (e.g., sensor, sound, and/or device specification data) is fed to the trained machine learning algorithm. The output of the machine learning algorithm is then compared against the true label of the input data to evaluate the algorithm's accuracy.

In various cases, in order to determine the best setting for the binary classifier, a k-fold cross validation technique is used. In particular, data from test drops is split into “k” equally sized non-overlapping sets, also referred to as “folds”. For each of the k-folds: (a) a binary classification model is trained using k−1 of the folds as training data; and (b) the trained model is tested on the remaining portion of the data. Steps (a) and (b) are re-run “k” times, and the reported performance measure is the average over “k” runs. In at least some embodiment, “k” is set to 10, and the performance measure is expressed in terms of the ‘Area Under The Curve’ (AUC) in an AUC-ROC (Receiver Operating Characteristics) curve. In general, the higher the AUC, the better the model is at performing binary classification.

Examples of supervised learning algorithms for training machine learning algorithms to perform binary classification can include, for example, Perceptron, Naive Bayes, Decision Tree, Logistic Regression, Artificial Neural Networks/Deep Learning, Support Vector Machine, and/or Random Forest algorithms.

In at least some example embodiments, a Random Forest technique is used, which is an ensemble technique that fits a number of decision tree classifiers on various sub-samples of the dataset and uses averaging to improve the predictive accuracy and control over-fitting. In a Random Forest, the parameters which can be trained, or re-fined, can include the number of decision trees in the forest, the maximum depth of each tree, and the minimum number of samples required for each leaf node. In at least some example embodiments, the Random Forest can have 1,000 trees, whereby each tree has a maximum depth of 15 nodes, and the minimum number of samples required for each leaf node is 1 and the minimum number of samples required to split an internal node is 2. The Random Forest can be trained using sensor data obtained in a time window of one minute, and using sensor data features obtained from the accelerometer 310h, magnetometer 310f, and one or more orientation sensors (roll sensor 310l, yaw sensor 310m and radar sensor 310m). The sensor data features obtained from each of the accelerometer 310h, magnetometer 310g and orientation sensors can include: minimum amplitude values, maximum amplitude values, difference between minimum and maximum amplitude values, mean amplitude values, and standard of deviation of amplitude values. In respect of the orientation sensor, the data feature values are determined using rotation data, which can be calculated according to Equation (1):

Rotation=\sqrt{Pitch²+Roll²+Yaw²} (1)

Using these input and training parameters, and using the training data generated as described above, the Random Forest can be trained under one hour, while maintaining an accuracy of approximately 95.47% in terms of the Area Under The Curve (AUC). In general, using a greater number of trees in the forest having a greater maximum depth can increase accuracy, however, at the cost of execution time. In some embodiments, the machine learning algorithm can be trained on processor 302. For example, training, validation and test data can be stored on memory 304, and the processor 302 may use the data to train an untrained algorithm. This can be performed at any time before performing methods 400 and 500. In other cases, the machine learning algorithm can be trained, for example, on server 210. Parameters for the trained algorithm may then be transmitted to electronic device 205, via network 215, and stored on memory 304. Processor 302 may then apply input data to the trained algorithm to generate output results. At act 514, the processor 302 may generate an output result based on the analysis at act 510. The output result 514 can identify whether or not a protective case was applied to the electronic device 205 at drop impact.

In various cases, all, or any portion, of method 500 may be performed on server 210, rather than processor 302. For example, in some cases, after extracting feature data in acts 504 and 506, the extracted feature data and/or device specifications may be sent, via network 215, to server 210. Server 210 may then analyze the data to determine whether a protective case was present on the electronic device 205 during drop impact. In particular, in these embodiments, the server 210 may host the trained machine learning algorithm which can be used to analyze at least one of the sensor and/or sound data, and the extracted feature data. In other cases, at least one of the raw sensor and/or sound data, and device specifications can be sent to server 210. Server 210 can extract features from at least one of the data and features, as well as analyze all of the data and features to determine the presence of a protective case.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A method for detecting presence of a protective casing on a portable electronic device during a drop impact of the device, the method comprising:
receiving, by at least one processor, a first indication that the portable electronic device is being dropped;
collecting, by the at least one processor, sensor data generated from at least one sensor coupled to the electronic device;
receiving, by the at least one processor, a second indication that the portable electronic device has experienced the drop impact;
analyzing, by the at least one processor, sensor data generated by the at least one sensor during a time frame between receiving the first indication and the second indication; and
determining, by the at least one processor, an output result based on the analyzing, wherein the output result indicates either: (i) the portable electronic device was protected by a protective case at a moment of drop impact; or (ii) the portable electronic device was not protected by a protective case at the moment of drop impact.

2. The method of claim 1, wherein the analyzing further comprises:
extracting, by the at least one processor, at least one feature from the sensor data generated by the at least one sensor during the time frame; and
applying, by the at least one processor, at least one machine learning algorithm to the at least one feature to generate the output result.

3. The method of claim 2, wherein the machine learning algorithm comprises a binary classifier, and the binary classifier is configured to classify the at least one feature into one of two mutually exclusive classes, including a first class indicating that the electronic device was protected by the protective casing at the moment of drop impact, and a second class indicating that the electronic device was not protected by the protective casing at the moment of drop impact.

4. The method of claim 2, wherein the machine learning algorithm comprises at least one of Perceptron, a Naive Bayes, a Decision Tree, a Logistic Regression, an Artificial Neural Network, a Support Vector Machine, and a Random Forest algorithm.

5. The method of claim 2, wherein the at least one feature comprises at least one of frequency values, amplitude values, energy values, data minimum and maximum values of at least one of the frequency, amplitude and energy values, difference between maximum and minimum values of at least one of frequency, amplitude and energy values, data average values of at least one of the frequency, amplitude and energy values, standard of deviation of the amplitude values from the sensor data in at least one of the time domain and frequency domain, a histogram of pixel color values, local binary pattern (LBP), histogram of oriented gradients (HOG), JET features, scale-invariant feature transform (SIFT) features, micro-JET features, micro-SIFT features, outline curvature of image objects, and reflectance based features comprising at least one of edge-slice and edge-ribbon features.

6. The method of claim 2, wherein the at least one feature comprises a plurality of features, and the at least one machine learning algorithm comprises a plurality of machine learning algorithms, and a different machine learning algorithm is applied to a different feature to generate a sub-output result, and wherein the sub-output results from each of the plurality of machine learning algorithms is aggregated to generate the output result.

7. The method of claim 2, wherein the at least one sensor comprises a plurality of sensors that each generate a respective sensor data set during the time frame, and the at least one processor is configured to extract at least one feature from each sensor data set.

8. (canceled)

9. (canceled)

10. The method of claim 1, wherein after receiving the first indication, the method further comprises:
initiating, by the at least one processor, a watchdog timer;
determining, by the at least one processor, that the watchdog timer has expired; and
determining, by the at least one processor, whether the second indication was received before the watchdog timer expired,
wherein when the second indication was received before the watchdog timer expired, the second indication that the portable electronic device has experienced the drop is generated, and when the second indication was not received before the watchdog timer expired, then the at least one processor is configured to discard data collected from the at least one sensor.

11. The method of claim 1, wherein the at least one processor is a processor of the portable electronic device.

12. (canceled)

13. The method of claim 1, wherein the at least one processor comprises at least one first processor of the electronic device, and at least one second processor of a server, and
wherein the at least one first processor receives the first indication, collects data generated from the at least one sensor and receives the second indication,
wherein a communication interface of the electronic device transmits to the server data collected during the time frame, and
wherein the at least one second processor analyzes data collected during the time frame and, determines the output result based on the analyzing.

14. (canceled)

15. A system for detecting the presence of a protective case on an electronic device during a drop impact of the device, the system comprising:
at least one sensor coupled to the electronic device;
at least one processor in communication with the at least one sensor, the at least one processor operable to:
receive a first indication that the electronic device is being dropped;
collect sensor data generated from the at least one sensor;
receive a second indication of the drop impact of the electronic device;
analyze sensor data generated by the at least one sensor during a time frame defined between the first indication and the second indication; and
determine, based on the analysis, an output result based on the analyzing, wherein the output result indicates that either: (i) the electronic device was protected by a protective case at a moment of drop impact; or (ii) the electronic device was not protected by a protective case at the moment of drop impact.

16. The system of claim 15, wherein to analyze the sensor data, the at least one processor is operable to:
extract at least one feature from the sensor data generated by the at least one sensor during the time frame; and
apply at least one machine learning algorithm to the at least one feature to generate the output result.

17. The system of claim 16, wherein the machine learning algorithm comprises a binary classifier, and the binary classifier is configured to classify the at least one feature into one of two mutually exclusive classes, including a first class indicating that the electronic device was protected by the protective casing at the moment of drop impact, and a second class indicating that the electronic device was not protected by the protective casing at the moment of drop impact.

18. The system of claim 16, wherein the machine learning algorithm comprises at least one of Perceptron, a Naive Bayes, a Decision Tree, a Logistic Regression, an Artificial Neural Network, a Support Vector Machine, and a Random Forest algorithm.

19. The system of claim 16, wherein the at least one feature comprises at least one of frequency values, amplitude values, energy values, data minimum and maximum values of at least one of the frequency, amplitude and energy values, difference between maximum and minimum values of at least one of frequency, amplitude and energy values, data average values of at least one of the frequency, amplitude and energy values, standard of deviation of the amplitude values from the sensor data in at least one of the time domain and frequency domain, a histogram of pixel color values, local binary pattern (LBP), histogram of oriented gradients (HOG), JET features, scale-invariant feature transform (SIFT) features, micro-JET features, micro-SIFT features, outline curvature of image objects, and reflectance based features comprising at least one of edge-slice and edge-ribbon features.

20. The system of claim 16, wherein the at least one feature comprises a plurality of features, and the at least one machine learning algorithm comprises a plurality of machine learning algorithms, and a different machine learning algorithm is applied to a different feature to generate a sub-output result, and wherein the sub-output results from each of the plurality of machine learning algorithms is aggregated to generate the output result.

21. The system of claim 16, wherein the at least one sensor comprises a plurality of sensors that each generate a respective sensor data set during the time frame, and the at least one processor is configured to extract at least one feature from each sensor data set.

22. (canceled)

23. (canceled)

24. The system of claim 15, wherein after receiving the first indication, the at least one processor is further operable to:
initiate a watchdog timer;
determine that the watchdog timer has expired; and
determine whether the second indication was received before the watchdog timer expired,
wherein when the second indication was received before the watchdog timer expired, the second indication that the portable electronic device has experienced the drop is generated, and when the second indication was not received before the watchdog timer expired, then the at least one processor is operable to discard data collected from the at least one sensor.

25. The system of claim 15, wherein the at least one processor is a processor of the portable electronic device.

26. (canceled)

27. The system of claim 15, wherein the at least one processor comprises at least one first processor of the electronic device, and at least one second processor of a server, and
wherein the at least one first processor is operable to receive the first indication, collect data generated from the at least one sensor and receive the second indication,
wherein a communication interface of the electronic device is operable to transmit to the server data collected during the time frame, and
wherein the at least one second processor is operable to analyze data collected during the time frame and, determine the output result based on the analyzing.

28. (canceled)
